(19) United States
(12) Patent Application Publication
(10) Pub. No.: US 2015/0003372 A1
(43) Pub. Date: Jan. 1, 2015

(54) CONTROLLING A TRANSMISSION OF MESSAGES FOR A SIGNALLING PROCEDURE BETWEEN A BASE STATION AND A USER EQUIPMENT

(71) Applicants: Bernhard Raaf, Neuried (DE); Esa Tapani Tiirola, Kempele (FI); Simone Redana, Munich (DE)

(72) Inventors: Bernhard Raaf, Neuried (DE); Esa Tapani Tiirola, Kempele (FI); Simone Redana, Munich (DE)

(73) Assignee: NOKIA SOLUTIONS AND NETWORKS OY, Espoo (FI)

(21) Appl. No.: 14/379,858

(22) PCT Filed: Feb. 28, 2012
(86) PCT No.: PCT/EP2012/053330

§ 371 Date: Aug. 20, 2014

(51) Int. Cl. H04W 72/04

(52) U.S. Cl. CPC H04W 72/0406
USPC 370/329

(57) ABSTRACT

It is described a method for controlling a transmission of messages for a signalling procedure between a base station and a user equipment via a radio transmission channel. The method comprises generating at least one message for the signalling procedure, wherein the at least one message comprises signalling procedure information and indicates control information being indicative for the presence of at least one subsequent message for the signalling procedure and/or for resources of the radio transmission channel being allocated to the at least one subsequent message, transmitting the at least one message between the base station and the user equipment, and controlling the transmission of the at least one subsequent message between the base station and the user equipment based on the control information.

### FIELD OF INVENTION

The present invention relates to the field of cellular networks, especially to an evolution of LTE networks, and in particular to networks comprising LTE networks and evolved LTE networks.

### ART BACKGROUND

In cellular network systems, there exists several signalling procedures, for instance for establishing a call. During call setup, but also during other signaling procedures, the exchanged messages are typically always the same because the involved machines execute predetermined programs rather than acting spontaneously. The parameters that are conveyed during these signaling procedures may however vary, e.g., the telephone number of a call, and therefore the procedures are not completely redundant.

Despite the repetitive nature of the message exchanges, for each messages not only the higher layer content needs to be exchanged, but also control information regarding the scheduling of these messages. In LTE, this is done by PDCCH (in HSDPA by HS-SCCH).

This costs additional capacity/overhead and also causes additional delay and increases latency. Latency is however a crucial design criterion for future systems, in particular during connection setup phases because the latency on all the messages accumulate to the delay experienced before useful connection starts.

It might be desirable to save both capacity and delay on the PDCCH especially for MTC (Machine type communications, e.g., sensors conveying their measurements) kind of operations, where the payload is quite small and therefore the PDCCH overhead is significant. Delay may be critical for real time applications and in particular for security related applications. Reduced delay also helps to save energy because the transceiver can be operated for a shorter time, which is another important aspect in particular for battery powered MTC devices.

There may be a need for an improved system and method being adapted to reduce control signalling.

### SUMMARY OF THE INVENTION

This need may be met by the subject matter according to the independent claims. Advantageous embodiments of the present invention are described by the dependent claims.

According to a first aspect of the invention there is provided a method for controlling a transmission of messages for a signalling procedure between a base station and a user equipment via a radio transmission channel. The method comprises generating at least one message for the signalling procedure, wherein the at least one message comprises signalling procedure information and indicates control information being indicative for the presence of at least one subsequent message for the signalling procedure and/or for resources of the radio transmission channel being allocated to the at least one subsequent message, transmitting the at least one message between the base station and the user equipment, and controlling the transmission of the at least one subsequent message between the base station and the user equipment based on the control information.

This aspect of the invention is based on the idea that control information related to a signalling procedure, like a typical call setup, typically shows a certain pattern for all the associated messages, which may be conveyed not via explicit control signaling, but in one or several message(s) of the signalling procedure. This may provide the advantage that control signaling overhead may be reduced. This may help to reduce delay as the delay incurred by the control message is saved and is in particular relevant when going to shorter TTIs (Transmission Time Intervals) in order to achieve lower latency, then the delay due to decoding control gets relatively bigger and bigger.

In order to reduce the latency most significantly, it is not only beneficial to indicate parameters that are conveyed via the control signaling by previous messages but even the existence of subsequent messages. However it is also possible to signal the existence of subsequent messages conventionally, e.g. via a single bit information, and only convey other control information or vice versa. Thus, the at least one message may indicate the presence of at least one subsequent message or resources of the radio transmission channel being allocated to the at least one subsequent message, or may indicate a combination of both, presence and resources.

As an example, there are three messages sent in downlink (DL) M1, M2 and M3. Typically resources are allocated for these messages via control signaling C1, C2 and C3 respectively at time T1, T2 and T3. The typical sequence is then:

T1: C1 indicates resources for M1

T2: C2 indicates resources for M2

T3: C3 indicates resources for M3

The sequence according to the described method might be:

T1: C1 indicates resources for M1; M1 (implicitly) indicates the presence of subsequent messages at time T2 and T3 and the resources allocated during T2 and T3

T2: implicit resources are known for M2 (no C2 needed)

T3: implicit resources are known for M3 (no C3 needed)

This may require inter-layer communication both in the base station (in the following also referred to as eNB) and the user equipment (UE) because the message M1 implicitly also generates the implicit resource allocation substituting the explicit control information C2 and C3.

The control information may be comprised or indicated in the at least one message in an explicit or implicit form. In the first case, the message may comprise addition information (for instance in the form of bits) referring to the control information (e.g., resources/TxRx parameters) for subsequent message(s). In the latter case, the message may indicate implicitly, for instance based on the form or kind of the message, that further messages will follow and that resources are allocated for the further messages. The resource allocation may then be based for instance on predefined rules or patters which are associated with specific messages.

The term “base station” in this context may denote any kind of physical entity being able to communicate with a user equipment or any other network device for signalling procedures using implicit control signalling. A base station in this context may be any kind of network device providing the required functionality for the method, it may also be a transceiver node in communication with a centralized entity. The base station may be for example a NodeB or eNB.

The base station/UE may either inform the UE/base station explicitly about following messages and allocated resources by sending a message comprising signalling information and control information or implicitly by sending the message.

According to an embodiment of the invention, the signalling procedure is a call setup procedure.

One example of a signalling procedure may be a call setup procedure for establishing a call. Such a procedure would be initiated by the UE or the eNB depending on whether it is a mobile originated or terminated call.

According to a further embodiment of the invention, the at least one message is a radio resource control (RRC) connection setup message.

The control information may be for example be piggybacked on higher layer message like an RRC connection setup message or the RRC configuration-reconfiguration or any other kind of message. “Piggybacked” in this context may refer to the way in which the control information is transmitted, i.e., not as a separate control signalling via a control channel (like physical downlink control channel, PDCCH) but as part of a normal signalling message.

According to a further embodiment of the invention, the at least one message and/or the at least one subsequent message are a downlink message and/or an uplink message.

The implicit control information may be transmitted in both directions, i.e., in downlink (DL) or uplink (UL) direction. Thus, the base station as well as the UE may allocate resources and indicate future messages.

Having only DL messages indicating control for later DL messages may be the simplest case and all decisions may be with the eNB, as is the usual approach. However, it may be desirable to have a more liberal approach and also allow that UL messages contain indications for control for subsequent DL messages, even if the UE does typically not have a comprehensive knowledge about the system as an eNB has and therefore may not be able to indicate control information in the most optimal way. However, the eNB can anyhow override this control information, and may thus be able to optimize the control further. But if the UE indicated control is reasonable in some cases, there may be still a saving. Similar arguments hold for the case that control for UL messages is indicated by previous DL messages, again the eNB may be in full control, and the case that UL messages provide implicit control for later UL messages, here the eNB can again, if necessary, supersede the implicit control by an explicit one. It may also be possible to apply the method only to some combinations of UL/DL, e.g. only to some of the cases discussed above.

According to a further embodiment of the invention, the control information allocates resources for uplink and/or downlink messages.

The control information being comprised in or indicated by the at least one message may allocate resources for future UL as well as DL messages. The control information may also allocate resources or indicate allocated resources for more than one future message.

This is motivated by the fact that certain messages are indicative for messages to be sent in the future as they are the beginning of typical message flows. Similarly, the content of the message is often also indicative of future messages.

According to a further embodiment of the invention, the control information indicated by the at least one message is dependent on the type of the at least one message and/or is dependent on information contained in the at least one message.

There are several options available how exactly to implicitly select control information based on the message flow appearing on higher layers. The control information may be dependent on the type or form of the at least one message. In this case, the control information may for instance indicate that the following messages are of the same type or form. Further, it may indicate how many or what kind of messages will follow. As the messages refer to a signalling procedure, the signal or message flow may be predefined at least in some parts.

The control information may further be dependent on information contained in the at least one message. The message may comprise explicit information about future or subsequent messages and corresponding allocated resources.

According to a further embodiment of the invention, the control information indicated by the at least one message is dependent on control information being indicative for allocated resources of the at least one message.

The control information being provided for future messages may correspond at least partially to control information being provided for past messages.

Referring to the example above, the content of the implicit control signals C2 and C3 can depend on the content of C1. For instance, the same resource assignment (PRB assignment) would be done as for C1, but different MCS (modulation and coding scheme) selection can be done, e.g., anticipating that the subsequent messages M2 and M3 may have different sizes compared to C1. If M2 is significantly bigger than M1, then also more PRBs can be implicitly assigned in C2 to accommodate the message.

According to a further embodiment of the invention, the method further comprises generating at least one subsequent message for the signalling procedure, wherein the at least one subsequent message comprises signalling procedure information and indicates control information being indicative for the presence of at least one further subsequent message for the signalling procedure and/or for resources of the radio transmission channel being allocated to the at least one further subsequent message.

Every message may comprise or indicate control information for following or subsequent messages.

According to a further embodiment of the invention, the control information indicated by the at least one subsequent message is dependent on the at least one message and the at least one subsequent message and/or is dependent on control information being indicative for allocated resources of the at least one message and the at least one subsequent message.

The control information contained in subsequent messages may be dependent on one or more previous messages, or more exactly on the control information contained in these messages. For instance, control information within later messages may only refer to changes and the rest of the allocation may remain unchanged.

According to a further embodiment of the invention, the control information comprises a first part being indicative for a predefined rule, wherein the predefined rule specifies the determination of a second part of the control information being indicative for the presence of at least one subsequent message for the signalling procedure and for resources of the radio transmission channel being allocated to the at least one subsequent message.

How to decode the control information may be defined in the standard or may be specified by predefined rules. A UE or base station would detect the implicit control information and compare it with predefined rules. The UE or base station may then detect the rule and proceed according to this rule. The detection of the implicit control information and the comparison with a predefined rule may also be based on a detection of a pattern within the message and a comparison of the detected pattern with predefined patterns which correspond to predefined rules.

According to a further embodiment of the invention, the method further comprises transmitting control information from the base station to the user equipment, wherein the control information supersedes the control information within the at least one message.

A base station may still send explicit control information via a control channel, which would then supersede the implicit control information of the messages. This may be done for the whole implicit control information or only parts of it.

According to a second aspect of the invention, there is provided a base station for controlling a transmission of messages for a signalling procedure between the base station and a user equipment via a radio transmission channel. The base station comprises a generation unit being adapted to generate at least one message for the signalling procedure, wherein the at least one message comprises signalling procedure information and indicates control information being indicative for the presence of at least one subsequent message for the signalling procedure and/or for resources of the radio transmission channel being allocated to the at least one subsequent message. The base station further comprises a transmitting unit being adapted to transmit the at least one message between the base station and the user equipment, and a control unit being adapted to control the transmission of the at least one subsequent message between the base station and the user equipment based on the control information.

The base station may be any type of access point or point of attachment, which is capable of providing a wireless access to a cellular network system. Thereby, the wireless access may be provided for a user equipment or for any other network element, which is capable of communicating in a wireless manner. The base station may be a NodeB, eNB, home NodeB or HeNB, or any other kind of access point. The base station may in particular be used for a B4G, LTE or 3GPP cell and communication.

The base station may comprise a receiving unit, for example a receiver as known by a skilled person. The base station may also comprise a transmitting or sending unit, for example a transmitter. The receiver and the transmitter may be implemented as one single unit, for example as a transceiver. The transceiver or the receiving unit and the sending unit may be adapted to communicate with the user equipment via an antenna.

The base station further comprises a generation unit and a control unit. The generation unit and the control unit may be implemented as single units or may be implemented for example as part of a standard control unit, like a CPU or a microcontroller.

According to a third aspect of the invention, there is provided a user equipment being adapted to communicate with a base station as described above.

The user equipment (UE) may be any type of communication end device, which is capable of connecting with the described base station. The UE may be in particular a cellular mobile phone, a Personal Digital Assistant (PDA), a notebook computer, a printer and/or any other movable communication device.

The user equipment may comprise a receiving unit or receiver which is adapted for receiving signals from the base station. The user equipment may comprise a transmitting unit for transmitting signals. The transmitting unit may be a transmitter as known by a skilled person. The receiver and the transmitting unit may be implemented as one single unit, for example as a transceiver. The transceiver or the receiver and the transmitting unit may be adapted to communicate with the base station via an antenna.

According to a further embodiment of the invention, the user equipment comprises a control unit being adapted to detect the control information being indicated by the at least one message being received from the base station and being adapted to control a transmission based on the detected control information.

The control unit may be further adapted to control and configure the transmission based on messages received from the base station in view of a signalling procedure. The received messages may comprise implicit information about future messages and corresponding control information, i.e., allocation of resources, time slots, etc. The control unit may detect the implicit information and may compare the implicit information with predefined rules for controlling the future transmission.

The control unit may also be adapted to carry out the above described method and to send implicit control information to the base station. The control unit may be implemented as a single unit or may be implemented for example as part of a standard control unit, like a CPU or a microcontroller.

In a more general way, the user equipment may communicate with the base and may be able to understand the messages and control information and to interpret the control accordingly. This may comprise for example interpreting the message M1 not only with its traditional meaning but also to detect and understand the implied control C1 and act accordingly as if C1 was transmitted. Generally, the receiver of the user equipment may basically carry out a mirror processing of the transmitter of the base station. For instance, instead of not transmitting a control information explicitly the receiver may realize that the explicit control has been made redundant and may react on the implicit control as if an explicit control had been sent, or instead of selecting and transmitting rules how to substitute explicit with implicit control, the user equipment may receive and apply them.

According to a fourth aspect of the invention, there is provided a cellular network system. The cellular network system comprises a base station as described above.

Generally herein, the method and embodiments of the method according to the first aspect may include performing one or more functions described with regard to the second, third or fourth aspect or an embodiment thereof. Vice versa, the base station, user equipment or cellular network system and embodiments thereof according to the second and third aspect may include units or devices for performing one or more functions described with regard to the first aspect or an embodiment thereof.

According to a fifth aspect of the herein disclosed subject-matter, a computer program for controlling a transmission of messages for a signalling procedure between the base station and a user equipment is provided, the computer program being adapted for, when executed by a data processor assembly, controlling the method as set forth in the first aspect or an embodiment thereof.

As used herein, reference to a computer program is intended to be equivalent to a reference to a program element and/or a computer readable medium containing instructions for controlling a computer system to coordinate the performance of the above described method.

The computer program may be implemented as computer readable instruction code by use of any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The herein disclosed subject matter may be realized by means of a computer program respectively software. However, the herein disclosed subject matter may also be realized by means of one or more specific electronic circuits respectively hardware. Furthermore, the herein disclosed subject matter may also be realized in a hybrid form, i.e. in a combination of software modules and hardware modules.

In the above there have been described and in the following there will be described exemplary embodiments of the subject matter disclosed herein with reference to a cellular network system, a base station, a user equipment and a method of controlling a transmission of messages for a signalling procedure between the base station and a user equipment. It has to be pointed out that of course any combination of features relating to different aspects of the herein disclosed subject matter is also possible. In particular, some embodiments have been described with reference to apparatus type embodiments whereas other embodiments have been described with reference to method type embodiments. However, a person skilled in the art will gather from the above and the following description that, unless otherwise notified, in addition to any combination of features belonging to one aspect also any combination between features relating to different aspects or embodiments, for example even between features of the apparatus type embodiments and features of the method type embodiments is considered to be disclosed with this application.

The aspects and embodiments defined above and further aspects and embodiments of the present invention are apparent from the examples to be described hereinafter and are explained with reference to the drawings, but to which the invention is not limited.

### BRIEF DESCRIPTION OF THE DRAWING

FIG. 1 shows a cellular network system according to an exemplary embodiment of the present invention.

FIG. 2 shows a message flow diagram for RRC signalling.

FIG. 3 shows a random access procedure.

FIG. 4 shows a base station and a user equipment within a cellular network system according to an exemplary embodiment of the invention.

It is noted that in different figures, similar or identical elements are provided with the same reference signs.

### DETAILED DESCRIPTION

In the following, embodiments of the herein disclosed subject matter are illustrated with reference to the drawings and reference to aspects of current standards, such as LTE, and their further developments. However, such reference to current standards is only exemplary and should not be considered as limiting the scope of the claims.

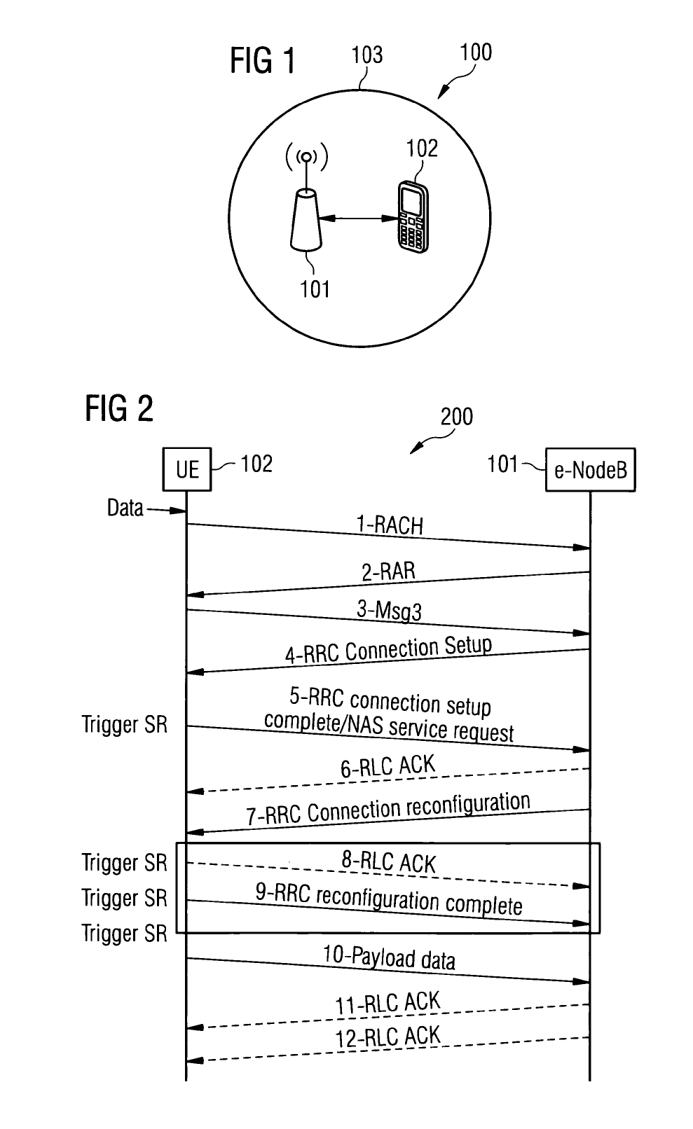

FIG. 1 shows a cellular network system 100. A user equipment 102 is served by a first cell 103 of the cellular network system. The first cell is assigned to a base station 101.

A signalling procedure, like a call setup procedure, may be carried out between the base station 101 and the user equipment 102. A message is generated for the signalling procedure. This message comprises signalling procedure information as well as control information being indicative for the presence of at least one subsequent message for the signalling procedure and for resources of the radio transmission channel being allocated to the at least one subsequent message. The message is then transmitted between the base station (eNB or eNodeB) and the user equipment (UE). A transmission of the subsequent message can then be controlled based on the control information being contained in the previous message.

The described method is based on the fact that, during call setup, but also during other signaling procedures, the exchanged messages are typically always the same because the involved machines execute predetermined programs rather than acting spontaneously. The parameters that are conveyed during these signaling procedures may however vary, e.g. the telephone number of a call, therefore the procedures are not completely redundant.

Despite the repetitive nature of the message exchanges, for each messages not only the higher layer content needs to be exchanged, but also control information regarding the scheduling of these messages. In LTE this is done by PDCCH (in HSDPA by HS-SCCH). This costs additional capacity/overhead and also causes additional delay and increases latency. Latency is however a crucial design criterion for future systems, in particular during connection setup phases because the latency on all the messages accumulate to the delay experienced before useful connection starts.

There may be a desire to save both capacity and delay on the PDCCH especially for MTC (Machine type communications, e.g. sensors conveying their measurements) kind of operations, where the payload is quite small and therefore the PDCCH overhead is significant. Delay may be critical for real time applications and in particular for security related applications.

FIG. 2 shows the current LTE procedure 200 required for conveying UL payload (step 10) from UE to eNB.

Step 1: RACH message from UE to eNB

Step 2: RAR message from eNB to UE

Step 3: Message from UE to eNB

Step 4: RRC connection setup from eNB to UE

Step 5: RRC connection setup complete/NAS service request from UE to eNB

Step 6: RLC ACK from eNB to UE

Step 7: RRD connection reconfiguration from eNB to UE

Step 8: RLC ACK from UE to eNB

Step 9: RRC reconfiguration complete from UE to eNB

Step 10: Payload data from UE to eNB

Step 11: RLC ACK from eNB to UE

Step 12: RLC ACK from eNB to UE

It can be seen that the procedure contains various messages (12 messages in total). It may take more than 100 ms to perform the entire procedure. The number of control signaling messages required to transmit payload data on PUSCH (step 10) is also considerable. For example, the total number of PDCCH needed for the procedure is typically more than ten.

By the herein described method and system, a method and system may be provided to reduce the control signaling drastically. There exists the so called semi-persistent scheduling, which allows to save control signaling for periodic messages e.g. VoIP packets, which can then be sent without any PDCCH. With a small periodicity this could be used to also reduce PDCCH overhead for message exchanges as the one in FIG. 2, but as it is only applicable to very regular messages the application is limited.

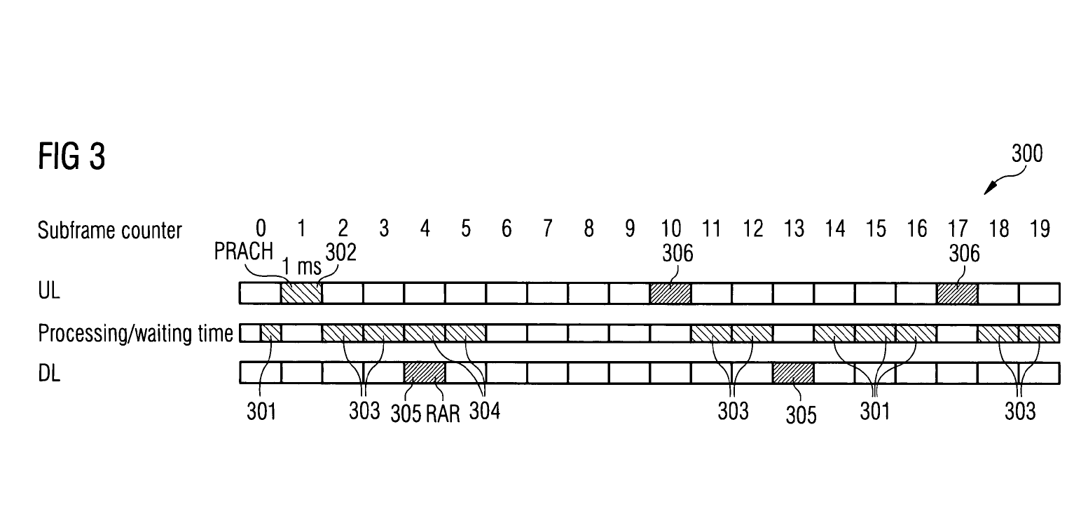

FIG. 3 illustrates a Random Access procedure 300. At the very beginning of the connection setup, during the RACH procedure the normal PDCCH cannot be used to schedule the first uplink message 306, partly because the eNB is not yet aware of the ID of the UE that sent the RACH 302 (only a shortened ID is included in the RACH payload). Therefore, instead of using PDCCH, a resource for the UE is conveyed in the RACH Response message and it is embedded in the higher layer information that is conveyed with the RAR 305 (Random Access Response). This is also very restrictive and may only cover the aspect of the herein described method to have scheduling information as part of a higher layer message. In this case the RAR is more like an alternate format of the PDCCH when PDCCH is inapplicable rather than a shorthand version of the PDCCH.

In FIG. 3, blocks 301 indicate the average UE waiting time prior to any SR transmission (PRACH periodicity is 1 ms) and prior to PUSCH transmission. Block 302 indicates the preamble transmission (1 ms). Blocks 303 indicate the eNB processing time prior to transmitting PDCCH. Blocks 304 indicate the ra-Response window size. Blocks 305 indicate a DL transmission (RAR and UL grant). Blocks 306 indicate PUSH transmission (1 ms).

According to the herein described method and system, control information related to a signalling procedure, for instance a typical call setup, pattern for all the associated messages is conveyed not via explicit control signaling, but in one or several message(s) and this one may even be piggybacked on higher layer message e.g. an RRC Connection Setup message or the RRC-configuration-reconfiguration or another message. There may be several options available how exactly to implicitly select control information based on the message flow appearing on higher layers.

The described method and system may provide the advantage of a reduced control signaling overhead. This may help to reduce delay as the delay incurred by the control message is saved and is in particular relevant when going to lower TTIs in order to achieve lower latency, then the delay due to decoding control gets relatively bigger and bigger.

Basically a specific message implicitly also includes a default PDCCH information for subsequent packets because it may be expected that a fixed pattern of subsequent messages will apply. The fixed pattern can be superseded by explicit PDCCH signaling.

In DL this may be easy as a wrong implicit allocation doesn't hurt much. At most the UE may try to decode a message that is not there and potentially send a NACK. There may be some default ACK/'NACK resource that does not collide with a resource related to an explicitly conveyed message. In UL it may be trickier, as UL resources may be blocked, even if the UE doesn't have anything to transmit. However in UL, an explicit allocation without resource indication can be used to clear the implicit allocation. There may be a shorthand signaling to temporary or permanently take away an UL resource from the UE e.g. via a modification of PHICH signaling, which only consumes a single bit signaling in DL. If the NodeB realizes that the implicit allocation is unneeded, it may then reuse those resources for other UEs, otherwise they are lost.

Many UEs can be easily multiplexed if messages come with a predetermined repetition rate e.g. every 40 ms rather than an irregular timing. Therefore, the predetermined patterns may also be allocated in such a regular manner, not due to limitations of scheduling possibilities of the individual UE but due to ease multiplexing of several implicit messages.

As explained above, according to an example, there may be three messages sent in DL M1, M2 and M3. Normally, resources are allocated for these messages via control signaling C1, C2 and C3 respectively at time T1, T2 and T3.

According to the herein described method and system, the sequence may be:

T1: C1 indicates resources for M1; M1 implicitly indicates the presence of subsequent messages at time T2 and T3 and the resources allocated during T2 and T3

T2: implicit resources are known for M2 (no C2 needed)

T3: implicit resources are known for M3 (no C3 needed)

The subsequent messages M2 and M3 may in turn trigger subsequent further allocations substituting further control messages C4, C5 etc. In this example, only DL messages trigger allocations for DL. However, also UL messages can trigger DL allocations and DL messages can trigger UL allocations or combinations of UL and DL allocations.

The content of the implicit control signals C2 and C3 can depend on the content of C1. E.g., typically the same resource assignment (PRB assignment) would be done as for C1, but different MCS selection can be done, e.g., anticipating that the subsequent messages M2 and M3 may have different sizes compared to C1. If M2 is significantly bigger than M1 then however also more PRBs can be implicitly assigned in C2 to accommodate the message.

The implicit control signals C2 and C3 can depend solely on the message type of M1, not on the content, e.g., the parameters. They can also depend on further information contained in M1, e.g., on parameters. These parameters might allow predicting the sizes of subsequent messages. Future implicit control signals can depend not only on a single previous message but on several ones, two or more (or even all previous ones), both on the control part, the message type and the detailed content.

HARQ on a previous message may delay subsequent messages accordingly. Some parameters in C2 might implicitly change if HARQ retransmissions were necessary on a previous message, i.e., if a retransmission was needed on M1. This may implicitly switch to a more robust MCS or use parameters used in the retransmission of M1 which was scheduled explicitly i.e. a different set of RBs compared to the initial transmission can then be used.

The method can work perfectly, if the message flow can be predicted precisely, this will however not always be possible. E.g., it may be hard to predict sizes of subsequent messages as there may be more than a single message flow that is possible. In such a case, the following options may be available:

1. Explicit control overrides implicit control. The eNB can always send an explicit control that supersedes the implicit one. This allows using arbitrary sequences of messages.

2. Explicit control augments implicit one. The eNB can modify/extend the implicit signaling. In this case, the entire content of the implicit signaling does not have to be repeated, but only differences have to be specified. This does not save on the number of control signaling messages needed, but the content is smaller (in LTE a lower aggregation level can be used for such control signaling). In this way, the overhead can still be reduced, but not so much the latency. The exact meaning of such augmentations can depend again on the previous messages. E.g., MCS schemes can be changed or the set of assigned PRBs to reflect changes in channel conditions.

3. Explicit control due to HARQ. Also HARQ, i.e., of the UE requests by sending a NACK by the UE in uplink because it misunderstood a message in DL, can implicitly indicate a retransmission in DL on the same resources at a predetermined time something like a synchronous retransmission. The eNB can then explicitly signal if it wants to send the message later instead or with different coding etc. So not only DL messages can influence control for subsequent DL messages but also UL signaling and control messages like the NACK mentioned above. Furthermore, due to the time lost in the HARQ process due to the retransmission subsequent messages are delayed accordingly as explained above.

4. Explicit control piggy backed onto UL control. In case of HARQ, the ACK/NACK signaling in UL may also contain information modifying the implicit control of subsequent DL messages and there may even be explicit information piggy backed on the signaling, i.e., there could be more than just one bit (ACK/NACK) but also another bit indicating whether MCS levels need to be increased or decreased. This may substitute full blown CQI (channel quality indicator) reporting, alternatively also a more comprehensive CQI may be triggered implicitly by a NACK without a full control information in the DL. Some indication, e.g., about which resources to be used for the CQI, might be sent in DL control nonetheless, but at least some control information may be implicitly derived from the ACK/NACK signaling or information piggy backed on it.

5. Additional explicit control. In order to squeeze in additional messages, e.g., for extensions of the message flow, it may be possible to send additional explicit control signals. The implicit control would still be applicable in this case but additional explicit control may be added.

6. Explicit control piggy backed onto higher layer messages. In order to allow liberal extensions of the scheme it may be possible to piggy back an explicit indication of subsequent control messages onto higher layer messages like M2. Because the control signaling has to be conveyed explicitly in this case, there may be no saving on the total number of payload to be transmitted, but there may be still a saving because it may be possible to code control and data together which typically provides a much better coding gain compared to the limited coding gain that is possible for control signals as the latter have a small number of bits only. Also latency can be saved due to making some control signaling redundant.

Rules to derive implicit control from previous messages can be known implicitly and can be fixed, i.e. standardized, but they can also be communicated explicitly and then substitute existing rules. Via such explicit communication the rule can be replaced completely or only partially modified (e.g. as far as MCS is concerned). Then the syntax how to convey rules might need to be predetermined i.e. standardized. Such rules can contain patterns which the UE will then match with the messages and in case the pattern matches there is a rule how to determine subsequent control information and potentially which parameters to derive (e.g. repeat) from a previous control. In case several patterns match, they can be ordered in increasing relevance in which case the most relevant match would be used.

Another option is to learn from explicit control augmenting implicit one as explained above, these augmentations can be declared to be either applicable to a specific instance only or can be declared to modify the rule that determines the implicit command and thus will apply again in subsequent message exchanges, rather than modifying the currently used control message only. The information that an explicit control is to be stored as a rule can be conveyed with that overriding control message. It can also be conveyed after the sequence of messages and declare that the changes done apply for several instances of the rule. This way there is no need to include the indication to change the relevant rule in each of the relevant explicit commands, thus saving overhead. Instead, after the message flow all explicit commands, or a subset of these, are declared to be incorporated in the rules. This will also cost some signaling, but that signaling can be done at any time as it is not in the critical path of the message flow, e.g. at a time when there is unused capacity available. If only a few explicit commands are to be included in the rules, indicating those commands (e.g. via the frame number at which they were sent or indicating a frame number range or another numbering scheme) costs less bit than indicating with a single bit for each explicit control whether it should modify the rule.

In summary, UL control can also be predicted based on DL control and (DL) messages and even uplink messages can be used to predict subsequent UL and DL control. C1 or M1 can predict multiple C2 and C3 etc. This may allow T3 to follow T2 immediately as neither processing nor communication has to be done in between. A single piggy backed information on M2 can predict multiple subsequent control messages C3, C4 etc.

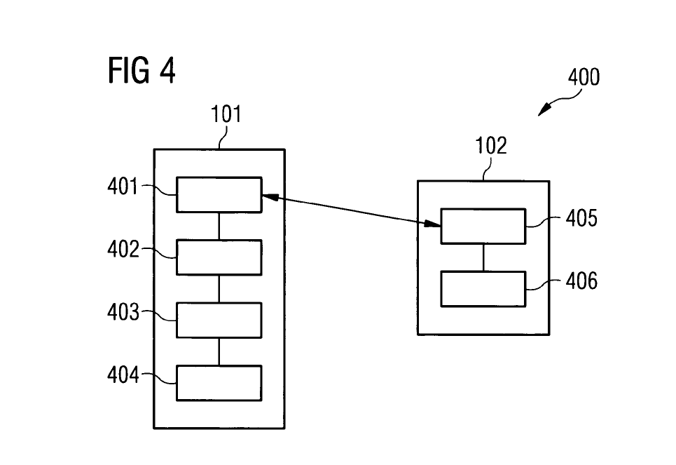

FIG. 4 shows a cellular network system 400 according to an exemplary embodiment of the invention. The cellular network system comprises a base station 101 and a user equipment 102 being served by the base station.

The base station comprises a generation unit 403, a transmitting unit 401 and a control unit 404. The generation unit is adapted to generate at least one message for a signalling procedure between the base station and the user equipment. The at least one message comprises signalling procedure information and control information being indicative for the presence of at least one subsequent message for the signalling procedure and for resources of the radio transmission channel being allocated to the at least one subsequent message. The transmitting unit transmits the at least one message between the base station and the user equipment.

The base station may also comprise a receiving unit 402 for receiving such a message from the user equipment 102. The control unit controls then the transmission of the at least one subsequent message between the base station and the user equipment based on the control information.

The base station may be any type of access point or point of attachment, which is capable of providing a wireless access to a cellular network system. Thereby, the wireless access may be provided for the user equipment, or for any other network element, which is capable of communicating in a wireless manner. The base station may be a NodeB, eNB, home NodeB or HeNB, or any other kind of access point.

The base station may comprise a receiving unit 402, for example a receiver as known by a skilled person. The base station may also comprise a transmitting or sending unit 401, for example a transmitter. The receiver and the transmitter may be implemented as one single unit, for example as a transceiver. The transceiver or the receiving unit and the sending unit may be adapted to communicate with the user equipment via an antenna.

The generation unit 403 and the control unit 404 may be implemented as single units or may be implemented for example as part of a standard control unit, like a CPU or a microcontroller.

The user equipment (UE) may be any type of communication end device, which is capable of connecting with the described base station. The UE may be in particular a cellular mobile phone, a Personal Digital Assistant (PDA), a notebook computer, a printer and/or any other movable communication device.

The user equipment may comprise a receiving unit or receiver which is adapted for receiving signals from the base station. The user equipment may comprise a transmitting unit for transmitting signals. The transmitting unit may be a transmitter as known by a skilled person. The receiver and the transmitting unit may be implemented as one single unit, for example as a transceiver 405. The transceiver or the receiver and the transmitting unit may be adapted to communicate with the base station via an antenna.

The user equipment may further comprise a control unit 406 for controlling and configuring the transmission based on control information received from the base station being implicitly contained in a message. The control unit may especially be adapted for detecting the implicitly control information. The control unit may be implemented as a single unit or may be implemented for example as part of a standard control unit, like a CPU or a microcontroller.

Having regard to the subject matter disclosed herein, it should be mentioned that, although some embodiments refer to a “base station”, “eNB”, etc., it should be understood that each of these references is considered to implicitly disclose a respective reference to the general term “network component” or, in still other embodiments, to the term “network access node”. Also other terms which relate to specific standards or specific communication techniques are considered to implicitly disclose the respective general term with the desired functionality.

It should further be noted that a base station as disclosed herein is not limited to dedicated entities as described in some embodiments. Rather, the herein disclosed subject matter may be implemented in various ways in various locations in the communication network while still providing the desired functionality.

According to embodiments of the invention, any suitable entity (e.g. components, units and devices) disclosed herein, e.g. the control unit, are at least in part provided in the form of respective computer programs which enable a processor device to provide the functionality of the respective entities as disclosed herein. According to other embodiments, any suitable entity disclosed herein may be provided in hardware. According to other—hybrid—embodiments, some entities may be provided in software while other entities are provided in hardware.

It should be noted that any entity disclosed herein (e.g. components, units and devices) are not limited to a dedicated entity as described in some embodiments. Rather, the herein disclosed subject matter may be implemented in various ways and with various granularities on device level while still providing the desired functionality. Further, it should be noted that according to embodiments a separate entity (e.g. a software module, a hardware module or a hybrid module) may be provided for each of the functions disclosed herein. According to other embodiments, an entity (e.g. a software module, a hardware module or a hybrid module (combined software/hardware module)) is configured for providing two or more functions as disclosed herein.

It should be noted that the term “comprising” does not exclude other elements or steps. It may also be possible in further refinements of the invention to combine features from different embodiments described herein above. It should also be noted that reference signs in the claims should not be construed as limiting the scope of the claims.

### LIST OF REFERENCE SIGNS

100 Cellular network system
101 Base station
102 User equipment
103 Cell
200 Message flow diagram for RRC signalling
300 Random access procedure
301 Average UE waiting time
302 Preamble transmission
303 eNB processing time
304 ra-ResponseWindowSize
305 DL transmission
306 PUSCH transmission
400 Cellular network system
401 Receiver of the base station
402 Generation unit of the base station
403 Transmitting unit of the base station
404 Control unit of the base station
405 Transceiver of the user equipment
406 Control unit of the user equipment

1. A method for controlling a transmission of messages for a signalling procedure between a base station and a user equipment via a radio transmission channel, the method comprising
generating at least one message for the signalling procedure, wherein the at least one message comprises signalling procedure information and indicates control information being indicative for the presence of at least one subsequent message for the signalling procedure and/or for resources of the radio transmission channel being allocated to the at least one subsequent message,
transmitting the at least one message between the base station and the user equipment, and
controlling the transmission of the at least one subsequent message between the base station and the user equipment based on the control information.

2. The method as set forth in claim 1, wherein the signalling procedure is a call setup procedure.

3. The method as set forth in claim 1, wherein the at least one message is a radio resource control connection setup message.

4. The method as set forth in claim 1, wherein the at least one message and/or the at least one subsequent message are a downlink message and/or an uplink message.

5. The method as set forth in claim 1, wherein the control information allocates resources for uplink and/or downlink messages.

6. The method as set forth in claim 1, wherein the control information indicated by the at least one message is dependent on the type of the at least one message and/or is dependent on information contained in the at least one message.

7. The method as set forth in claim 1, wherein the control information indicated by the at least one message is dependent on control information being indicative for allocated resources of the at least one message.

8. The method as set forth in claim 1, the method further comprising
generating at least one subsequent message for the signalling procedure, wherein the at least one subsequent message comprises signalling procedure information and indicates control information being indicative for the presence of at least one further subsequent message for the signalling procedure and for resources of the radio transmission channel being allocated to the at least one further subsequent message.

9. The method as set forth in claim 8, wherein the control information within the at least one subsequent message is dependent on the at least one message and the at least one subsequent message and/or is dependent on control information being indicative for allocated resources of the at least one message and the at least one subsequent message.

10. The method as set forth in claim 1, wherein the control information comprises a first part being indicative for a predefined rule, wherein the predefined rule specifies the determination of a second part of the control information being indicative for the presence of at least one subsequent message for the signalling procedure and for resources of the radio transmission channel being allocated to the at least one subsequent message.

11. The method as set forth in claim 1, the method further comprising transmitting control information from the base station to the user equipment, wherein the control information supersedes the control information within the at least one message.

12. A base station for controlling a transmission of messages for a signalling procedure between the base station and a user equipment via a radio transmission channel, the base station comprising
a generation unit being adapted to generate at least one message for the signalling procedure, wherein the at least one message comprises signalling procedure information and indicates control information being indicative for the presence of at least one subsequent message for the signalling procedure and/or for resources of the radio transmission channel being allocated to the at least one subsequent message,
a transmitting unit being adapted to transmit the at least one message between the base station, and
a control unit being adapted to control the transmission of the at least one subsequent message between the base station based on the control information.

13-15. (canceled)

16. The base station as set forth in claim 12, wherein the signaling procedure is a call setup procedure.

17. The base station as set forth in claim 12, wherein the at least one message is a radio resource control connection setup message.

18. The base station as set forth in claim 12, wherein the control information allocates resources for uplink and/or downlink messages.

19. The base station as set forth in claim 12, wherein the control information indicated by the at least one message is dependent on the type of the at least one message and/or is dependent on information contained in the at least one message.

20. The base station as set forth in claim 12, wherein the base station is further adapted to
generate at least one subsequent message for the signalling procedure, wherein the at least one subsequent message comprises signalling procedure information and indicates control information being indicative for the presence of at least one further subsequent message for the signalling procedure and for resources of the radio transmission channel being allocated to the at least one further subsequent message.

21. The base station as set forth in claim 12, wherein the control information comprises a first part being indicative for a predefined rule, wherein the predefined rule specifies the determination of a second part of the control information being indicative for the presence of at least one subsequent message for the signalling procedure and for resources of the radio transmission channel being allocated to the at least one subsequent message.

22. The base station as set forth in claim 12, wherein the base station is further adapted to
transmit control information from the base station to the user equipment, wherein the control information supersedes the control information within the at least one message.

23. A computer program product, the computer program product being tangibly embodied on a non-transitory computer-readable storage medium and including instructions that, when executed, are configured to cause at least one processor to perform a method for controlling a transmission of messages for a signalling procedure between a base station and a user equipment via a radio transmission channel, the method comprising
generating at least one message for the signalling procedure, wherein the at least one message comprises signalling procedure information and indicates control information being indicative for the presence of at least one subsequent message for the signalling procedure and/or for resources of the radio transmission channel being allocated to the at least one subsequent message,
transmitting the at least one message between the base station and the user equipment, and
controlling the transmission of the at least one subsequent message between the base station and the user equipment based on the control information.
